(19) United States
(12) Patent Application Publication
(10) Pub. No.: US 2020/0410030 A1
(43) Pub. Date: Dec. 31, 2020

(54) CLOUD SEARCH-BASED RECOMMENDATION METHOD, APPARATUS, DEVICE AND READABLE STORAGE MEDIUM

(71) Applicant: BAIDU ONLINE NETWORK TECHNOLOGY (BEIJING) CO., LTD., BEIJING (CN)

(72) Inventors: LING BAI, Beijing (CN); Haitao Liu, Beijing (CN)

(21) Appl. No.: 16/703,554

(22) Filed: Dec. 4, 2019

(30) Foreign Application Priority Data
Jun. 26, 2019 (CN) 201910562451.7

(51) Int. Cl. G06F 16/9538; G06F 16/9535; G06F 9/455

(52) U.S. Cl. CPC G06F 16/9538; G06F 9/45529; G06F 16/9535

(57) ABSTRACT

The present disclosure provides a cloud search-based recommendation method, apparatus, device and readable storage medium, including: determining a plurality of third-party applications according to search information input by a user; judging whether the third-party applications are installed, if a third-party application of the plurality third-party applications is not installed, generating a virtual application for simulating the third-party application, and acquiring a search result through the virtual application; determining and displaying a recommendation result corresponding to the search information according to the search result. In the solutions provided by the present disclosure, a virtual application is generated for the application that is not installed, so that a user terminal can still use a function provided by the third-party application in the case that the third-party application is not installed.

### CROSS-REFERENCE TO RELATED APPLICATIONS

This application claims priority to Chinese Patent Application No. 201910562451.7, filed on Jun. 26, 2019, which is hereby incorporated by reference in its entirety.

### TECHNICAL FIELD

The present disclosure relates to search technology, and in particular, relates to a cloud search-based recommendation method, apparatus, device and readable storage medium.

### BACKGROUND

At present, with the diversity of service content applications, more and more applications are being developed, especially the applications for mobile terminal. If a user wants to use functions of a plurality of applications, the corresponding applications need to be installed. These applications may provide a search function, that is, feeding back corresponding products, services, information, and the like based on a keyword input by the user.

But, when using these applications, the user needs to open different applications, respectively, and operate in them. For example, when the user needs to order a takeout, if the user wants to select among different applications, the user needs to open several pieces of food delivery software and browse through them one by one.

In this application scenario, a plurality of applications need to be installed on the user terminal, and the user terminal needs to run the plurality of applications at the same time, which needs strong performance of the user terminal. In addition, the user needs to switch between the plurality of applications, which brings inconvenience in operation, resulting in a poor user experience to the user.

### SUMMARY

The present disclosure provides a cloud search-based recommendation method, apparatus, device and readable storage medium, to solve various problems a user faced in the prior art when the user needs to simultaneously use functions provided by a plurality of third-party applications.

A first aspect of the present disclosure provides a cloud search-based recommendation method, including:

determining a plurality of third-party applications according to search information input by a user;

judging whether the third-party applications are installed, if a third-party application of the plurality third-party applications is not installed, generating a virtual application for simulating the third-party application, and acquiring a search result through the virtual application;

determining and displaying a recommendation result corresponding to the search information according to the search result.

Another aspect of the present disclosure provides a cloud search-based recommendation apparatus, including:

a determining module, configured to determine a plurality of third-party applications according to search information input by a user;

a judging module, configured to judge whether the third-party applications are installed;

a generating module, configured to, if a third-party application of the plurality third-party applications is not installed, generate a virtual application for simulating the third-party application, and acquire a search result through the virtual application;

a recommending module, configured to determine and display a recommendation result corresponding to the search information according to the search result.

Still another aspect of the present disclosure provides a cloud search-based recommendation device, including:

a memory;

a processor; and

a computer program;

where the computer program is stored in the memory and configured to be executed by the processor to implement the cloud search-based recommendation method as described above in the first aspect.

Another aspect of the present disclosure provides a computer readable storage medium on which a computer program is stored, and the computer program is executed by the processor to implement the cloud search-based recommendation method as described above in the first aspect.

The technical effects of the cloud search-based recommendation method, apparatus, device and readable storage medium provided by the present disclosure are:

the present disclosure provides the cloud search-based recommendation method, apparatus, device and readable storage medium, including: determining a plurality of third-party applications according to search information input by s user; judging whether the third-party applications are installed, if a third-party application of the plurality third-party applications is not installed, generating a virtual application for simulating the third-party application, and acquiring a search result through the virtual application; and determining and displaying a recommendation result corresponding to the search information according to the search result. In the method, the apparatus, the device, and the readable storage medium provided by the present disclosure, a virtual application is generated for the application that is not installed, so that a user terminal can still use the function provided by the third-party application in the case that the third-party application is not installed. Meanwhile, a user can simultaneously use shortcut function services of many other different applications when the user only installs a single application. Moreover, the method, the apparatus, the device, and the readable storage medium provided by the present disclosure can determine a plurality of third-party applications according to the search information input by the user, and a corresponding search result can be acquired based on each third-party application, and thereby, the functions provided by a plurality of applications could be used at the same time without a need to switch among the plurality of applications.

### BRIEF DESCRIPTION OF THE DRAWINGS

FIG. 1 is a flowchart of a cloud search-based recommendation method according to an example embodiment of the present disclosure.

FIG. 1A is a schematic diagram of a recommendation result according to an example embodiment of the present disclosure.

FIG. 2 is a flowchart of a cloud search-based recommendation method according to another example embodiment of the present disclosure.

FIG. 3 is a structure diagram of a cloud search-based recommendation apparatus according to an example embodiment of the present disclosure.

FIG. 4 is a structure diagram of a cloud search-based recommendation apparatus according to another example embodiment of the present disclosure.

FIG. 5 is a structure diagram of a cloud search-based recommendation device according to an example embodiment of the present disclosure.

### DETAILED DESCRIPTION OF THE EMBODIMENTS

With the increasing of the number of applications, if a user wants to use the functions of these applications, these applications need to be installed on a user terminal, and when these applications are used at the same time, the terminal needs to open a plurality of applications at the same time. This requires high performance on the user terminal, and the user cannot use a function of an application that is not installed.

According to the method provided by the embodiments of the present disclosure, when a user conducts a search, a virtual application of a third-party application that is not installed can be generated, and a search result corresponding to search information can be acquired through the virtual application. Even if the third-party application is not installed on the user terminal, the user can still use the function provided by the third-party application. Further, a search result corresponding to the search information can also be acquired through the installed third-party application. Thereby, the user terminal is enabled to provide a user with functions of a plurality of third-party applications, without a need to switch among a plurality of applications.

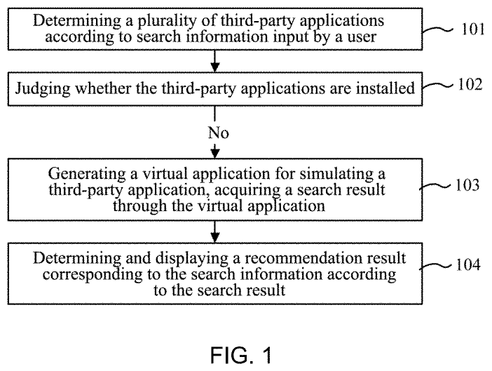

FIG. 1 is a flowchart of a cloud search-based recommendation method according to an example embodiment of the present disclosure.

As shown in FIG. 1, the cloud search-based recommendation method provided in this embodiment includes:

Step 101, determining a plurality of third-party applications according to search information input by a user.

The method provided in this embodiment is executed by a user terminal, the user terminal may be, for example, an electronic device, such as a mobile phone, a tablet computer, a computer, or the like.

The user terminal may connect to a background server of a third-party application through a network. For example, a third-party application can be installed on the user terminal, and the terminal can interact with the background server of the third-party application through a function provided by the third-party application.

Specifically, some third-party applications, such as food delivery applications, taxi applications, and so on, may be installed on the user terminal. But, since there are a large number of third-party applications, it is impossible to install all the applications on the user terminal, and therefore, there are still some applications that are not installed on the user terminal.

Further, the method provided in this embodiment may be encapsulated in an application, and the application is installed on the user terminal, and thereby the terminal can execute the method provided in this embodiment.

In practical application, when the user desires to search among a plurality of applications, the user may open the application that is set with the method provided by the present embodiment, and inputs the search information in the application.

The input ways of the search information can be set according to needs, for example, a plurality of options such as food, travel, shopping, etc. can be set on a homepage of the application. In this case, the user can input the search information by way of selection. In addition, an input box for the search information may be set on the homepage of the application, and the user may input a keyword therein to input the search information.

Specifically, after the user inputs the search information, the user terminal may determine a plurality of corresponding third-party applications according to the search information. The third-party application refers to an application that can feed back a search result corresponding to the search information. For example, if the user inputs food-related search information, the third-party application may be an application related to food delivery, group buying, and the like. If the user inputs travel-related search information, the third-party application may be a taxi application.

Step 102, judging whether the third-party applications are installed.

Further, it can be judged whether the determined third-party applications are installed on the user terminal. Specifically, judgement can be made for each of the third-party applications.

If a corresponding third-party application is not installed, step 103 may be executed for the third-party application.

Step 103, generating a virtual application for simulating a third-party application, and acquiring a search result through the virtual application.

In the prior art, if a third-party application is not installed on the user terminal, the user terminal cannot use the function provided by the third-party application. In the method provided by this embodiment, by generating a virtual application for simulating a third-party application, the function provided by the third-party application can be used through the virtual application.

In practical application, the search information may be sent to the virtual application, and the virtual application interacts with the background server of the above third-party application that is not installed, to acquire the search result.

The virtual application may generate a search request according to the search information, and send the search request to the background server of the third-party application that is not installed, the background server may determine the search result according to the search request, and feed back the search result to the virtual application. For example, if a third-party application A is determined according to the search information, the background server of A is B, and it is determined that the application A is not installed on the user terminal, then a virtual application A′ may be generated, A′ may generate a search request according to the search information, and sends the search request to the server B, and A′ can also receive the search result that is fee back by the B.

Step 104, determining and displaying a recommendation result corresponding to the search information according to the search result.

Specifically, if a corresponding third-party application is installed, the user terminal can interact with the background server through the installed application, thereby acquiring the search result.

In practical application, the user terminal may acquire a plurality of search results through the determined plurality of third-party applications, regardless of whether or not the corresponding applications are installed on the user terminal.

After the user terminal acquires the plurality of search results, the recommendation result corresponding to the search information may be determined according to the search results.

Specifically, the user terminal may extract specific searched content included in the search results, and may also exclude the search result with the same content but a high price, and determine the content recommended to the user according to the remaining search result(s). For example, when the search information is food-related information, the user terminal can determine the same dish of the different stores among the plurality of search results, and compare the prices of them, and then may exclude the dish with a high price.

Further, the searched content in the remaining search result(s) may also be sorted. For example, a food preference of a user may be predicted according to historical consumption data of the user, thereby determining the recommendation content from the remaining searched content.

In practical application, the searched content can be sorted by considering multi-dimensional information such as user preference, restaurant location, and food price, and so on.

The recommendation result may be generated according to the recommendation content and its order, and displayed to the user. The recommendation result may be in a picture-text mode, for example, a dish picture may be displayed, and the price, the distance to the user, and other information may be displayed below the picture.

FIG. 1A is a schematic diagram of a recommendation result according to an example embodiment of the present disclosure.

As shown in FIG. 1A, it is a recommendation result corresponding to a food-related search information.

Specifically, the number of pieces of recommendation content displayed in the recommendation result may be set according to requirements. For example, three pieces of recommendation content may be displayed. At this time, the three pieces of recommendation content may be selected according to the order of the searched content, and displayed on the user terminal.

If the user is not satisfied with the three pieces of recommendation content, the user terminal can be operated to display more recommendation content, and then, the user terminal may further determine more recommendation content according to the order of the searched contents, generate and display the recommendation result according to the recommendation content.

The method provided in this embodiment is used to acquire a search result, the method is executed by a device that is set with the method provided in this embodiment, and the device is usually implemented by hardware and/or software.

The cloud search-based recommendation method provided by the embodiment includes: determining a plurality of third-party applications according to search information input by the user; judging whether the third-party applications are installed, and if a third-party application of the plurality third-party applications is not installed, generating a virtual application for simulating the third-party application, and acquiring a search result through the virtual application; determining and displaying a recommendation result corresponding to the search information according to the search result. In the method provided by the embodiment, a virtual application is generated for the application that is not installed, so that the user terminal can still use the function provided by a third-party application in the case that the third-party application is not installed. Meanwhile, a user can simultaneously use shortcut function services of many other different applications when the user only installs a single application. Moreover, the method, the apparatus, the device, and the readable storage medium provided by the present embodiment can determine a plurality of third-party applications according to the search information input by the user, and a corresponding search result can be acquired based on each third-party application, and thereby the user can use the functions provided by the plurality of applications at the same time without a need to switch among a plurality of applications.

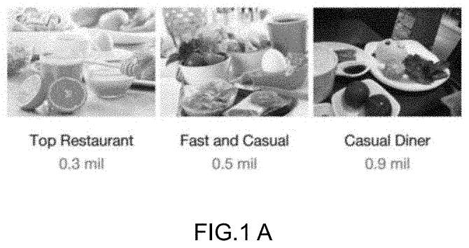

FIG. 2 is a flowchart of a cloud search-based recommendation method according to another example embodiment of the present disclosure.

As shown in FIG. 2, a cloud search-based recommendation method provided by the embodiment includes:

Step 201, determining a search category according to search information.

Similar to the embodiment shown in FIG. 1, the method provided by this embodiment may be set in an application, and the application may be installed on a user terminal, and thereby the user terminal can execute the method provided by the embodiment.

Specifically, a user may open the application that is set with the method provided by this embodiment, and input search information therein. For example, the user may input at least one keyword and click a confirm button. Category information, such as food, taxi, etc., may be displayed on a page of the application, and the user may input the search information by way of selecting these categories.

Further, the terminal may determine a search category according to the search information, in response to the user's operation.

In an implementation, if the search information is input by way of inputting a keyword, the user terminal may determine, according to the keyword, a category of thereof. For example, the category of the keyword can be understood through semantic understanding technology. A corresponding relationship between the search category and the keyword may also be preset to determine the search category of the keyword input by the user.

In another embodiment, if the search information is input by way of selecting a category, the user terminal may determine the classification information of the user operation in response to the user's operation, thereby determining the search category.

The search category refers to a category corresponding to the search information input by the user, and the third-party application also has a category label, such as an application of a food-delivery category, an application of a food category, an application of a shopping category, and so on.

Step 202, determining a plurality of third-party applications corresponding to the search category according to a preset corresponding relationship.

Specifically, a corresponding relationship between the search category and the third-party applications is preset. For example, the corresponding relationship can be set by way of setting a label for each search category. A database may also be maintained, in which the third-party applications included in each search category are configured.

Further, the corresponding third-party applications may be determined according to the preset corresponding relationship and the search category. For example, if the search category is the shopping category, then a plurality of third-party applications corresponding to the shopping category may be determined.

In practical application, search results can be acquired according to the determined third-party applications.

Step 203, judging whether the above third-party applications are installed.

Step 203 is similar to step 102 in the specific principle and implementation, and will not be repeated here.

If so, executing step 204, otherwise, executing step 205.

Step 204, acquiring a search result through a third-party application.

In practical application, a part of the third-party applications are installed on the user terminal, and if a determined third-party application is installed on the user terminal, the search result can be directly acquired through the installed application.

The search information may be sent to the third-party application, and a search request is sent to a server corresponding to the third-party application through the third-party application.

Specifically, the search information may be sent to the above third-party application installed on the terminal. For example, the search information may be sent to the third-party application by the application directly operated by the user. For example, the application executing the method provided by the embodiment is a search application, and a determined third-party application is an application A, and the application A is installed on the user terminal, then the search application may send the search information to the application A.

Further, the third-party application has a function of interacting with its background server, and therefore, the third-party application can generate the search request according to the received search information, and send the search request to the background server.

In practical application, after receiving the search request, the background server may determine the search result corresponding to the search request based on a set search logic, and feed back the search result to the third-party application, so that the search result that is fed back by the server and corresponding to the search request is received through the third-party application.

Step 205, generating a virtual application for simulating the third-party application.

Step 205 is similar to step 103 in the specific principle and implementation of generating a virtual application, and will not be repeated here.

Step 206, sending the search information to the virtual application, and sending a search request to a server corresponding to the third-party application through the virtual application.

Step 207, receiving a search result that is fed back by the server and corresponding to the search request through the virtual application.

If the third-party application is not installed on the user terminal, then a virtual application may be generated to simulate the function of the third-party application. For example, it can be configured to simulate a part of the functions of a third-party application, thereby reducing a size of the virtual application.

Specifically, the virtual application may have a function of generating a search request, and may also have a function of interacting with a background server of the third-party application corresponding to the virtual application.

Further, the third-party application can actively access the search application, so that the search application can generate the virtual application corresponding to the third-party application.

In practical application, the virtual application may generate the search request according to the received search information, and send the search request to a background server of the third-party application corresponding to the virtual application.

After receiving the search request, the server may determine the search result corresponding to the search request based on the set search logic, and feed back the search result to the virtual application, so that the search result that is fed back by the server and corresponding to the search request is received through the virtual application.

In the method provided by the embodiment, a protocol may also be set, the third-party application server may feed back the search result based on the protocol, and the third-party application may also communicate with the search application through the protocol.

When the third-party application is installed on the user terminal, the search result acquired by the user terminal can only be displayed in the third-party application, and other applications cannot directly read the search result in the third-party application; similarly, for the virtual application, other applications cannot directly read the search result acquired by the virtual application. Therefore, in the method provided by the embodiment, a protocol is set, so that the search application can acquire the search results received by the third-party application and the virtual application.

In step 204, a search result is acquired through the third-party application, and then step 208 may also be executed; in step 207, the search result is acquired through the virtual application, and then step 209 may also be executed.

Step 208, the third-party application generates a second recommendation data object according to the acquired search result, and generates a second serialized data object corresponding to the second recommendation data object.

Specifically, after receiving the search result, the third-party application may generate a second recommendation data object according to the search result. The second recommendation data object may specifically be a Slice object generated according to a protocol.

Further, the third-party application may further serialize the generated second recommendation data object, e.g. a Slice data object, to generate a second serialized data object.

In practical application, the third-party application also sends the second serialized data object to the search application, so that the search application receives the serialized data object including the search result information.

Step 209, the virtual application generates a first recommendation data object according to the acquired search result, and generates a first serialized data object corresponding to the first recommendation data object.

After receiving the search result, the virtual application may generate the first recommendation data object according to the search result. The first recommendation data object may specifically be a Slice object generated according to a protocol.

Specifically, the virtual application may further serialize the generated first recommendation data object, e.g. a Slice object, to generate a first serialized data object.

In practical application, the virtual application sends the first serialized data object to the search application, so that the search application receives the serialized data object including the search result information.

In addition, a third-party protocol is set for communication with the server of the third-party application, where the third-party protocol is automatically generated according to a preset field.

Specifically, a framework protocol may be preset, and the third-party platform that accesses the search software of the method of the embodiment, may preset a field, thereby generating a third-party protocol.

For example, the third-party platform can set preset fields including distance, price, store name, etc., then these fields can be added to the third-party protocol based on the framework protocol. When the third-party platform feeds back the search result, the search result including the content of the preset fields may be fed back.

The third-party protocol may be used by the user terminal that executes the method provided by the embodiment, to communicate with the server of the third-party platform. For example, the third-party platform may feed back the search result to the virtual application or the third-party application in the user terminal according to the protocol; the virtual application or third-party application may also analyze the search result according to the third-party protocol.

Correspondingly, after receiving the search result, the virtual application or the third-party application may acquire the search data, such as distance, price, store name, etc., included in the search result based on the third-party protocol and generate the corresponding recommendation data object.

Specifically, that the virtual application generates a first recommendation data object according to the acquired search result, includes:

the virtual application analyzes the search result according to the third-party protocol, acquires first search data, and generates the first recommendation data object according to the first search data;

that the third-party application generates a second recommendation data object according to the acquired search result, includes:

the third-party application analyzes the search result according to the third-party protocol, acquires second search data, and generates the second recommendation data object according to the second search data.

Step 210, receiving the first serialized data object and/or the second serialized data object sent by the virtual application and/or the third-party application.

Step 211, deserializing the first serialized data object and/or the second serialized data object to obtain the search result.

The search application can receive the second serialized data object sent by the third-party application, and may also receive the first serialized data object sent by the virtual application. Serialization is a process of converting state information of an object into a form that may be stored or transmitted, and specifically, is a process of converting a state of the object into a byte stream. During serialization, the object writes its current state to a temporary or persistent storage area. Since a Slice object cannot be transmitted, therefore, it can be serialized so as to be smoothly transferred between applications.

The search application can deserialize the received serialized data object, thereby acquiring the included search results. Specifically, when the first serialized data object is received, the first serialized data object is deserialized; and when the second serialized data object is received, the second serialized data object is deserialized, where an opposite process of creating an object from a byte stream is called deserialization.

Step 212, determining the searched content according to the search results, and determine the recommendation information from the searched content according to a preset recommendation rule and key information.

The user terminal may acquire the search results fed back by the background servers of a plurality of third-party applications through the function provided by the search application. When there are a large number of the third-party applications, there are also many feedback results, and the searched content included therein is also large. For example, when five third-party applications are determined, on average, each third-party application platform feeds back 10 pieces of searched content, and the user terminal may acquire a total of 50 pieces of searched content. Therefore, the user terminal may further screen the recommendation information therein.

Specifically, a recommendation rule may be preset for determining recommendation information from the searched content. The recommendation rule may also be associated with the search category, that is, a corresponding preset recommendation rule may be determined according to the search category. For example, in the recommendation rule of the food category, the recommendation content may be screened according to the dimensions such as distance, price, user preference, and so on; and in the recommendation rule of the shopping category, the recommendation content may be screened according to the dimensions such as user evaluation, price, and so on.

Step 213, displaying a recommendation result according to the recommendation information.

Further, the user terminal may display a recommendation result obtained according to the screened recommendation information. Specifically, a recommendation data object, e.g. a slice object, may be generated according to the recommendation information, and the object may be displayed by SliceView.

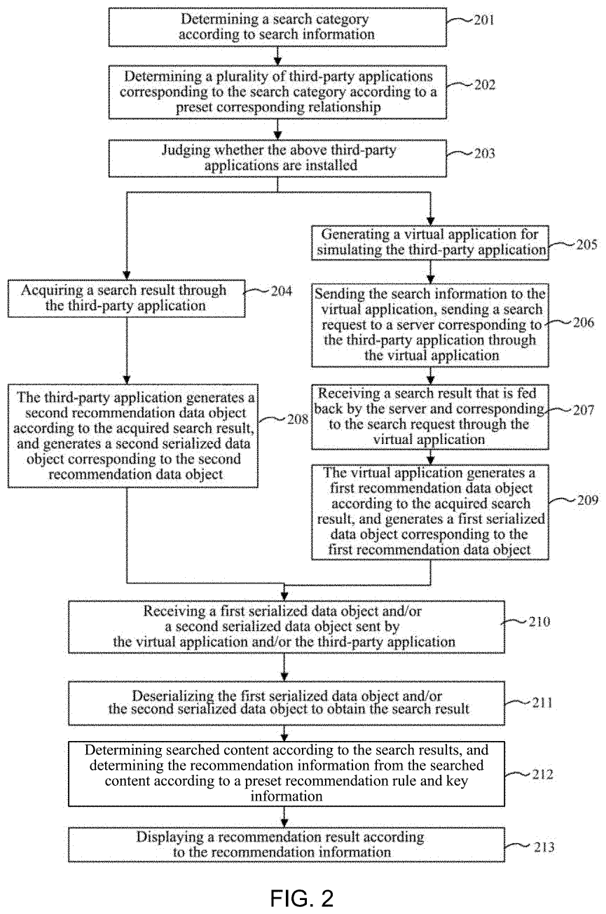

FIG. 3 is a structural diagram of a cloud search-based recommendation apparatus according to an example embodiment of the present disclosure.

As shown in FIG. 3, the cloud search-based recommendation apparatus provided by the embodiment includes:

a determining module 31, configured to determine a plurality of third-party applications according to search information input by a user;

a judging module 32, configured to judge whether the third-party applications are installed;

a generating module 33, configured to, if a third-party application of the plurality third-party applications is not installed, generate a virtual application for simulating the third-party application, and acquire a search result through the virtual application;

a recommending module 34, configured to determine and display a recommendation result corresponding to the search information according to the search result.

The cloud search-based recommendation apparatus provided by the embodiment includes: a determining module, configured to determine a plurality of third-party applications according to search information input by a user; a judging module, configured to judge whether a third-party application is installed; the generating module, configured to, if a third-party application of the plurality third-party applications is not installed, generate a virtual application for simulating the third-party application, and acquire a search result through the virtual application; and a recommending module, configured to determine and display the recommendation result corresponding to the search information according to the search result. In the apparatus provided by the embodiment, a virtual application is generated for the application that is not installed, so that the user terminal can still use the function provided by the third-party application in the case that the third-party application is not installed. Meanwhile, the user can simultaneously use the shortcut function services of many other different applications when the user only installs a single application. Moreover, the apparatus provided by the embodiment can determine a plurality of the third-party applications according to the search information input by the user, and the corresponding search result can be acquired based on each third-party application, and thus the functions provided by a plurality of applications can be used at the same time without a need to switch among a plurality of applications.

The specific principle and implementation of the cloud search-based recommendation apparatus provided by the embodiment are similar to the embodiment shown in FIG. 1, and will not be repeated here.

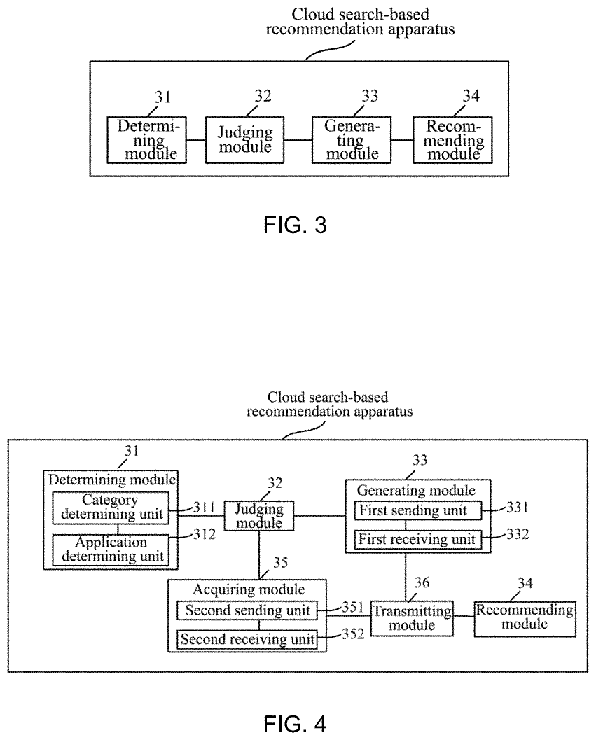

FIG. 4 is a structure diagram of a cloud search-based recommendation apparatus according to another example embodiment of the present disclosure.

As shown in FIG. 4, on the basis of the above embodiment, in the cloud search apparatus provided by the embodiment, the determining module 31 includes:

a category determining unit 311, configured to determine a search category according to the search information;

an application determining unit 312, configured to determine a plurality of third-party applications corresponding to the search category according to a preset corresponding relationship.

In an embodiment, the generating module 33 includes:

a first sending unit 331, configured to send the search information to the virtual application, and send the search request to a server corresponding to the third-party application through the virtual application;

a first receiving unit 332, configured to receive the search result that is fed back by the server and corresponding to the search request through the virtual application.

In an embodiment, if the third-party application is installed; the apparatus further includes an acquiring module 35, configured to:

acquiring a search result through the third-party application.

In an embodiment, the acquiring module 35 includes:

a second sending unit 351, configured to send the search information to the third-party application, and send the search request to a server corresponding to the third-party application through the third-party application;

a second receiving unit 352, configured to receive the search result that is fed back by the server and corresponding to the search request through the third-party application.

In an embodiment, a transmitting module 36 is further included;

after the generating module 33 acquires the search result through the virtual application, the transmitting module 36 controls the virtual application to generate a first recommendation data object according to the acquired search result, and generates a first serialized data object corresponding to the first recommendation data object;

and/or, after the acquiring module 35 acquires the search result through the third-party application, the transmitting module 36 controls the third-party application to generate a second recommendation data object according to the acquired search result, and generate a second serialized data object corresponding to the second recommendation data object.

In an embodiment, a third-party protocol is set for communication with the server, where the third-party protocol is automatically generated according to a preset field;

the transmitting module 36 is specifically configured to:

control the virtual application to analyze the search result according to the third-party protocol, acquire first search data, and generate the first recommendation data object according to the first search data;

the transmitting module 36 is also specifically configured to:

control the third-party application to analyze the search result according to the third-party protocol, acquire second search data, and generate the second recommendation data object according to the second search data.

In an embodiment, before the recommending module 34 determines and displays the recommendation result corresponding to the search information according to the search result, the transmitting module 36 is further configured to:

receive the first serialized data object and/or the second serialized data object sent by the virtual application and/or the third-party application;

deserializing the first serialized data object and/or the second serialized data object to obtain the search result.

In an embodiment, the recommending module 34 is specifically configured to:

determine the searched content according to the search result, and determining recommendation information in the searched content according to a preset recommendation rule;

display the recommendation result according to the recommendation information.

The specific principle and implementation of the cloud search-based recommendation apparatus provided by the embodiment are similar to the embodiment shown in FIG. 2, and will be not repeated here.

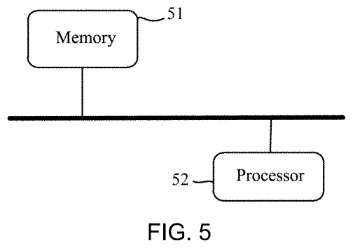

FIG. 5 is a structural diagram of a cloud search-based recommendation device according to an example embodiment of the present disclosure.

As shown in FIG. 5, the cloud search-based recommendation device provided by the embodiment includes:

a memory 51;

a processor 52; and

a computer program;

where the computer program is stored in the memory 51, and configured to be executed by the processor 52 to implement any one of cloud search-based recommendation methods described above.

The embodiment further provides a computer readable storage medium on which a computer program is stored, the computer program is executed by a processor to implement any one of the cloud search-based recommendation methods described above.

It may be understood by those ordinary skilled in the art that: all or part of the steps to implement the various method embodiments described above may be accomplished by a program instructing relevant hardware. The foregoing program may be stored in a computer readable storage medium. When the program is executed, the steps including the above method embodiments are executed; and the foregoing storage medium includes: various media that can store program code, such as ROM, RAM, magnetic disk, or optical disk and so on.

Finally, it should be noted that the above embodiments are merely used to illustrate the technical solutions of the present disclosure, and are not intended to limit them; although the present disclosure has been described in detail with reference to the foregoing embodiments, those ordinary skilled in the art should understand that they may still modify the technical solutions recorded in the foregoing embodiments, or some or all of the technical features may be equivalently substituted; and the modifications or substitutions do not make the essence of the corresponding technical solutions depart from the scope of the technical solutions of the embodiments of the present disclosure.

What is claimed is:

1. A cloud search-based recommendation method, comprising:
determining a plurality of third-party applications according to search information input by a user;
judging whether the third-party applications are installed, if a third-party application of the plurality third-party applications is not installed, generating a virtual application for simulating the third-party application, and acquiring a search result through the virtual application;
determining and displaying a recommendation result corresponding to the search information according to the search result.

2. The method according to claim 1, wherein the acquiring a search result through the virtual application, comprising:
sending the search information to the virtual application, and sending a search request to a server corresponding to the third-party application through the virtual application;
receiving the search result that is fed back by the server and corresponding to the search request through the virtual application.

3. The method according to claim 1, wherein if the third-party application is installed, the method further comprises:
acquiring the search result through the third-party application.

4. The method according to claim 3, wherein the acquiring the search result through the third-party application, comprising:
sending the search information to the third-party application, and send the search request to the server corresponding to the third-party application through the third-party application;
receiving the search result that is fed back by the server and corresponding to the search request through the third-party application.

5. The method according to claim 3, wherein after the acquiring the search result through the third-party application, the method further comprises:
generating, by the virtual application, a first recommendation data object according to the acquired search result, and generating a first serialized data object corresponding to the first recommendation data object;
and/or, after the acquiring the search result through the third-party application, the method further comprises:
generating, by the third-party application, a second recommendation data object according to the acquired search result, and generating a second serialized data object corresponding to the second recommendation data object.

6. The method according to claim 5, wherein a third-party protocol is set for communication with a server, wherein the third-party protocol is automatically generated according to a preset field;
the generating, by the virtual application, a first recommendation data object according to the acquired search result, comprises:
analyzing, by the virtual application, the search result according to the third-party protocol, acquiring first search data, and generating the first recommendation data object according to the first search data;
the generating, by the third-party application, a second recommendation data object according to the acquired search result, comprises:
analyzing, by the third-party application, the search result according to the third-party protocol, acquiring second search data, and generating the second recommendation data object according to the second search data.

7. The method according to claim 5, wherein before the determining and displaying a recommendation result corresponding to the search information according to the search result, the method further comprises:
receiving the first serialized data object and/or the second serialized data object sent by the virtual application and/or the third-party application;
deserializing the first serialized data object and/or the second serialized data object to obtain the search result.

8. The method according to claim 1, wherein the determining and displaying a recommendation result corresponding to the search information according to the search result, comprises:
determining searched content according to the search result, and determining the recommendation information from the searched content according to a preset recommendation rule;
displaying the recommendation result according to the recommendation information.

9. The method according to claim 1, wherein the determining a plurality of third-party applications according to search information input by a user, comprises:
determining a search category according to the search information;
determining a plurality of the third-party applications corresponding to the search category according to a preset corresponding relationship.

10. A cloud search-based recommendation apparatus, comprising: a memory, a processor, and a computer program, wherein the computer program is stored in the memory, and when running the computer program, the processor is configured to:
determine a plurality of third-party applications according to search information input by a user;
judge whether the third-party applications are installed;
if a third-party application of the plurality third-party applications is not installed, generate a virtual application for simulating the third-party application, and acquire a search result through the virtual application;
determine and display a recommendation result corresponding to the search information according to the search result.

11. The apparatus according to claim 10, wherein the processor is configured to:
send the search information to the virtual application, and send a search request to a server corresponding to the third-party application through the virtual application;
receive the search result that is fed back by the server and corresponding to the search request through the virtual application.

12. The apparatus according to claim 10, wherein if the third-party application is installed, the processor is further configured to:
acquire the search result through the third-party application.

13. The apparatus according to claim 12, wherein the processor is configured to:
send the search information to the third-party application, and send a search request to a server corresponding to the third-party application through the third-party application;
receive the search result that is fed back by the server and corresponding to the search request through the third-party application.

14. The apparatus according to claim 12, wherein the processor is further configured to perform at least one of:
after acquiring the search result through the virtual application, controlling the virtual application to generate a first recommendation data object according to the acquired search result, and generating a first serialized data object corresponding to the first recommendation data object;
or, after acquiring the search result by the third-party application, controlling the third-party application to generate a second recommendation data object according to the acquired search result, and generating a second serialized data object corresponding to the second recommendation data object.

15. The apparatus according to claim 14, wherein a third-party protocol is set for communication with a server, wherein the third-party protocol is automatically generated according to a preset field;
the processor is configured to:
control the virtual application to analyze the search result according to the third-party protocol, acquire the first search data, and generate the first recommendation data object according to the first search data;
the processor is further configured to:
control the third-party application to analyze the search result according to the third-party protocol, acquire second search data, and generate the second recommendation data object according to the second search data.

16. The apparatus according to claim 14, wherein before determining and displaying the recommendation result corresponding to the search information according to the search result, the processor is further configured to:
receive at least one of: the first serialized data object sent by the virtual application or the second serialized data object sent by the third-party application;
deserialize at least one of: the first serialized data object or the second serialized data object to obtain the search result.

17. The apparatus according to claim 10, wherein the processor is configured to:
determine searched content according to the search result, and determine the recommendation information from the searched content according to the preset recommendation rule;
display the recommendation result according to the recommendation information.

18. The apparatus according to claim 17, wherein the processor is configured to:
determine a search category according to the search information;
determine a plurality of the third-party applications corresponding to the search category according to a preset corresponding relationship.

19. A computer readable storage medium, comprising a computer program stored thereon,
wherein the computer program is executed by the processor to implement the method of claim 1.
